(19) United States
(12) Patent Application Publication
(10) Pub. No.: US 2003/0014762 A1
(43) Pub. Date: Jan. 16, 2003

(54) Subscriber internet interface system and apparatus

(76) Inventors: Richard David Conover, Hatboro, PA (US); Richard Peter DePaolis, Coventryville, PA (US); Kevin Joseph Donaghy, Malvern, PA (US); Michael David Guiher, Warminster, PA (US); Mary Catherine Stabenau, Yardley, PA (US); Robert Michael Stack, Douglassville, PA (US); Christopher Xavier Miller, Audubon, PA (US); Scott Charles Kreisler, Boyertown, PA (US)

Correspondence Address: DUANE MORRIS LLP, 100 COLLEGE ROAD WEST, SUITE 100, PRINCETON, NJ, 08540-6604, US

(21) Appl. No.: 09/971,202

(22) Filed: Oct. 4, 2001

Related U.S. Application Data
(60) Provisional application No. 60/305,596, filed on Jul. 13, 2001.

(51) Int. Cl. H04N 7/173

(52) U.S. Cl. 725/110; 725/109; 725/111

(57) ABSTRACT

A cable television system having bidirectional capability has subscribers with “set-top” converters which have no web browser capability. A server at the head-end or hub of the cable television system is equipped with one or more web browsers. The video representing each web page is applied to a cable modem termination system and combined with identification of the address or identifier of the subscriber for whom the web page is destined. The cable modem converts the data into a form suitable for transmission over the downstream function of the cable to the subscribers. At each subscriber, the web information is applied to a cable modem, which extracts the web page information and its destination information, and couples the information onto a bus. That subscriber whose memorized unique address corresponds to the destination uses the web page video information to update a memory buffer, which in general contains or stores a complete web page. The subscriber controls the web browser by a user input device such as a keyboard or mouse, and the commands are ultimately applied to the subscriber's cable modem for transmission over the upstream cable path to the head end. At the head end, the cable modem termination system routes the commands from each subscriber to the web browser server, so that each subscriber can control his individual browser (223).

This patent application claims priority of a provisional patent application titled, “Subscriber Internet Interface System and Apparatus”, Ser. No. 60/305,596 filed Jul. 13, 2001 in the name of Conover et al.

### FIELD OF THE INVENTION

This invention relates to the provision of internet service over a cable system which also provides television access to subscribers, and an adapter or “set-top box” which interfaces with the cable system and the television receiver acting as a monitor.

### BACKGROUND OF THE INVENTION

The Internet has in a surprisingly short time become a major communication path with widespread utilization. It is used for business communications, shopping, information provision, and entertainment. The availability of Internet service has heretofore been limited to those persons having access to a computer connected to the Internet. Home internet connections are limited, in many locations, to two-wire telephone lines. Such lines are woefully deficient in bandwidth, which in turn results at least in slow data transfers. The slow data transfers, in turn, limit the availability of streaming real-time communications such as video and audio, and make all forms of communication painfully slow. The infrastructure for high-speed Internet access is missing in many parts of the country, and such access is available, if at all, only by way of satellite communications systems.

Cable television (CATV) systems serve many locations which have low-bandwidth telephone service. Cable television systems connect to the homeowner with coaxial cable, which has a much greater bandwidth than two-wire telephone lines. The cable television system may transmit analog television signals or digitized television signals. A typical cable television system includes a “head-end” where television signals are received from satellite relays, and where the satellite signals are processed for redistribution over the cable system. The cable system itself typically includes “trunk” or main cables which distribute the “downstream” signals over the region served by the CATV provider with relatively great signal-to-noise ratio (SNR) signals, and branch cables which tap television signals from the trunk cables, and distribute the signals to the regions around the trunk cables. Both the trunk and distribution cables require trunk and “line” amplifiers, respectively, spaced along their lengths to help to overcome cable losses. The “two-way” or “bidirectional” cable television system may also include a “return” or “upstream” signal path, by which signals may be transmitted from subscriber locations to the head end of the cable television system; this requires that the trunk and line amplifiers have bidirectional capability. Such bidirectional capability is often provided by frequency multiplexing, in which the downstream signals occupy the frequency range from about 54 MHz to 350 or more MHz, and the upstream signals are in the range of 5 to 30 MHz. Computers can be fitted with cable modems to take advantage of the bandwidth afforded by cable television service. The cable modem allows wide-bandwidth or high-speed Internet communication between the subscriber and the “head end” of the CATV system.

Widespread use of computers has occurred only in the last fifteen years or so. Computers are still, one hopes, in their infancy, and are considered by some to be unreliable as well as difficult to understand and to operate. Consequently, there is a segment of the population which is not computer-literate, yet within that group are many who recognize the advantages of Internet connectivity. Attempts have been made to devise television receivers adapted for use in cable television systems, which incorporate so much of computer equipment as may be required for internet access, but without other computer capabilities. In some cases, the adaptation is by way of a “set-top” box which interfaces with the television receiver and with the CATV cable, so that the television receiver, when used with the Internet capability, is simply a video monitor. Such adapted television receivers, or set-top boxes, should require less skill to operate than a full personal computer, and may be more useful to some. Nevertheless, such an adapted television receiver includes a processor and at least some other components of a personal computer, requires a keyboard or some substitute therefor, and for that reason tends to be almost as expensive as a computer.

A proposed system which never found actual market use included a personal computer (or its equivalent) located at the head-end of a two-way cable television system, adapted for interacting with the internet. In this system, the keyboard and mouse were at the subscriber's location, and signals related to the keyboard and mouse signals were modulated so as to be transmissible over the upstream or return path of the cable system to the personal computer at the head end. The monitor information generated by the personal computer was modulated for transmission over the downlink television path back to all subscribers to the system. This proposed system never found use, as the internet signals associated with a single viewer consumed an entire television channel in the forward path, so the number of potential subscribers was limited and consequently the estimated cost was high, and in addition there was a lack of privacy, in that the signal for each subscriber was viewable by all subscribers.

Improved arrangements for connecting cable television subscribers to the Internet are desired.

### SUMMARY OF THE INVENTION

A system according to an aspect of the invention is for delivering television and internet access to a plurality of subscribers lacking web browsers. The system includes a bidirectional path defining an upstream direction and a downstream direction, and branching from a small number of termini or locations at the upstream terminus of the bidirectional path to a large number of subscriber locations at the downstream termini of the bidirectional path. A hub is located at one of said small number of locations. In a preferred embodiment of the invention, the upstream hub is a head-end of a cable television system, and the bidirectional path is a cable distribution system. The system includes a source of television signals at the hub, for generating a plurality of television signals modulated onto radio-frequency carriers, and television signal coupling means at the hub for coupling the television signals modulated onto radio-frequency carriers to the at least one bidirectional path, whereby, or as a result of which, the television signals are transmitted in a downstream direction over the at least one path to the plurality of subscribers. The system also includes at least one web browser associated with the hub for accessing the Internet under control of subscriber command signals applied thereto, and generates signals representative of web pages. A browser page coding arrangement is located at the hub, and is coupled to the web browser, for converting the signals representative of web pages into digital signals encoded with identifier information unique to that one of the subscribers using the web browser. A modulating arrangement is located at the hub and is coupled to the coding arrangement (710) for modulating the digital signals encoded with identifier information onto an RF carrier, and for coupling the resulting web page information carrier onto the downstream direction of the bidirectional path, whereby, or as a result of which, the digital signals which are encoded with identifier information arrive at all the subscriber locations. The system further includes a modem located at each subscriber location. The modem includes an RF port and a digital signal port, for demodulating the modulation on a carrier having the frequency of the RF carrier applied to the RF port, and for coupling the resulting signals to the digital port, and for modulating digital signals arriving at the digital port onto a carrier at the frequency of the RF carrier. At each subscriber location, an arrangement is provided for routing to a television receiver those television signals arriving from the hub, and for routing the RF carrier flowing in the downstream direction of the bidirectional path to the RF port of the modem, and for routing the carrier at the frequency of the RF carrier from the RF port of the modem to flow in the upstream direction in the bidirectional path. At each subscriber location, controllable memory is provided for temporary storage of the signals representative of web pages. At each subscriber location, a means is provided, which means is coupled to the digital port of the modem for reading the identifier information, for comparing the identifier information with stored identifier information unique to the subscriber, and for (a) commanding the memory to store the signals representative of web pages when the identifier information indicates that the web pages are destined for the local subscriber, whereby the memory updates at least a portion of its contents, and for (b) not commanding the memory when the identifier information indicates that the web pages are destined for a subscriber other than the local subscriber, whereby, or in which case, the memory continues to store its current information contents. At each subscriber location of the system, a display control and modulation arrangement is coupled to the memory, for recurrently reading the memory, and for converting the information so read into television format signals modulated onto a television-frequency carrier, to thereby form television signals representative of the web page. At each subscriber location, means are provided for coupling the television signals representative of the web page to a television receiver for display of the web page thereon. At each subscriber location, a subscriber command interface reading arrangement is coupled to the modem, for receiving subscriber commands related to the web browser, and for coupling the subscriber commands to the digital port of the modem, whereby the modem modulates the subscriber commands for transmission in the upstream direction over the bidirectional path to the hub. At the hub, a further modem function, which may be a bidirectional function of the modulating arrangement and the browser page coding arrangement, is provided for receiving and demodulating the subscriber commands, and for coupling the commands to the web browser.

According to another aspect of the invention, a cable television subscriber set-top converter lacking a web browser, and which includes a memory holding an identifier unique to the subscriber, at least in the cable television system with which it is used. The converter includes a broadband communications input port for receiving television signals modulated onto RF carriers and digital web page video signals identified, by carrying the unique identifier, as destined to a particular subscriber. An arrangement is provided for coupling the cable television signals to a television receiver signal port, to which the RF input port of a television receiver may be coupled. The converter also includes an arrangement for coupling the digital web page video signals to a cable modem. The cable modem is for converting the digital web page video signals into a format according to a predetermined standard, which may be TCP/IP in one embodiment, and for coupling the video signals in the predetermined standard onto a bus. A memory and a processor are coupled to the bus. The processor reads the unique identifier, and causes the memory to be updated, at least in part, only in response to correspondence between the unique identifier of the associated converter and the identifier associated with the received video signals. Thus, the memory is updated only with information relating to a web page destined for the local subscriber. The processor further includes a user input device interface, and couples user commands applied to the user input device interface to the modem. A display controller is coupled to the bus, for recurrently reading the memory, to thereby recurrently produce a stream of data representing a scanned web page, and for converting the stream of data into signals conforming to a standard baseband television format. An RF modulator is coupled to the display controller for receiving the signals conforming to a standard baseband television format, and for converting the signals into a radio-frequency television signal. An arrangement is coupled to the RF modulator and to the television receiver signal port, for making the radio-frequency television signal accessible to an external television receiver. A user input device signal input port is coupled to the user interface input port of the processor, for providing a path for the flow to the processor of subscriber web command signals produced by an external input device. As a result, or whereby, the processor couples the commands to the cable modem, and the cable modem modulates the commands onto an upstream RF carrier. Also, each subscriber can command, from his location, a web browser which is remote from the location of the subscriber, and view the web pages resulting from commands on a television receiver.

### BRIEF DESCRIPTION OF THE DRAWINGS

FIG. 1 is a simplified block diagram of a prior-art cable television distribution system including a head end, transmission system, and subscribers;

FIG. 2 is a simplified block diagram of a head end modified for use, and including a cable modem termination system in accordance with an aspect of the invention;

FIG. 3 is a simplified block diagram of the equipment at a system subscriber in accordance with an aspect of the invention;

FIG. 4 is a simplified block diagram of a cable modem which may be used in the subscriber set-top box arrangement of FIG. 3;

FIG. 5 is a simplified block diagram of a video controller and memory at a subscriber location in a set-top converter in accordance with an aspect of the invention;

FIG. 6 is a simplified flow chart or diagram, illustrating the logic flow of microprocessor 334 to perform in accordance with an aspect of the invention; and

FIG. 7 is a simplified block diagram of a cable modem termination system which may be used in the arrangement of FIG. 2 to perform head-end functions according to an aspect of the invention.

### DESCRIPTION OF THE INVENTION

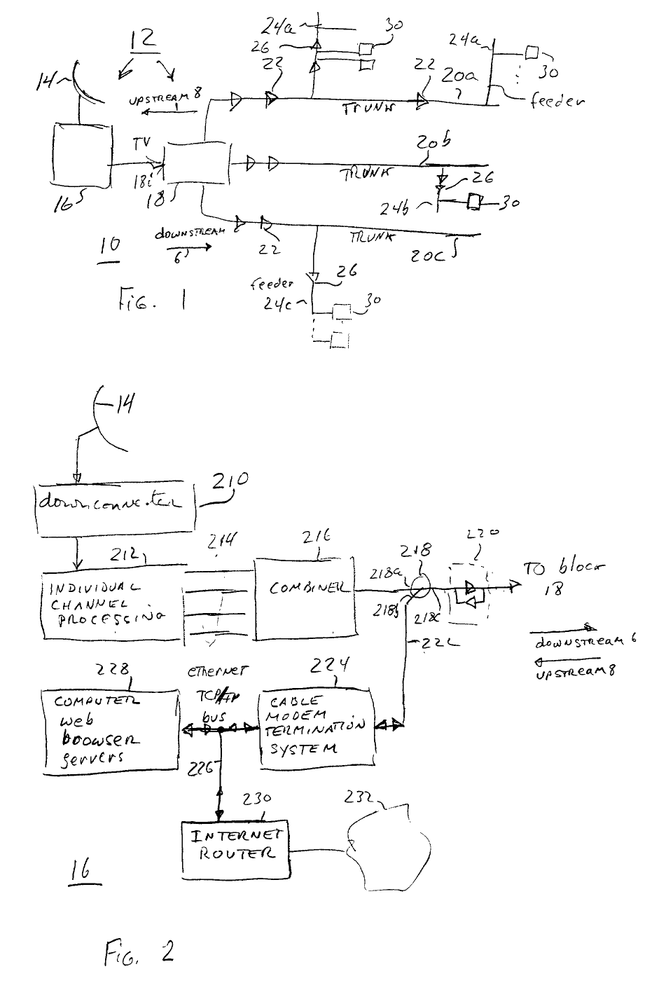

In FIG. 1, a cable television system 10 includes a “head end” or hub 12 including one or more satellite antennas 14 for receiving carrier signals from one or more communication satellites. The carrier signals carry analog or digital television signals, or both. The television signals are processed by demodulation or other processes in a block 16, and applied to an input port 18i of a further block 18, which represents the cable transmission processing and amplifiers, for producing a plurality of single-channel signals on a set 20 of trunk cables, which may include one or more trunk cables, designated 20a, 20b, and 20c. Each trunk cable of set 20 includes one or more trunk amplifiers, some of which are designated 22. The television signals are typically not provided to subscribers directly from the trunk cables 20a, 20b, and 20c, but are instead provided by way of distribution lines or feeders, representative ones of which are designated 24a, 24b, and 24c. Each of these feeder lines may include additional amplifiers, known as feeder amplifiers, some of which are designated as 26. Each individual subscriber is represented in FIG. 1 as a representative block 30. Each block 30 receives its television signals from a feeder line 24a, 24b, or 24c, either at the location of a feeder amplifier or at another location along the feeder line.

In some cable television systems, the “downstream” signal transmission so far described in conjunction with FIG. 1, represented by the arrow designated 6, is supplemented by “upstream” transmission capability, provided by a bidirectional transmission function of the various trunk and feeder amplifiers. The upstream direction is indicated by the arrows designated 8. The cable distribution system may be considered to have a single upstream terminus at port 18i, or the upstream end of each of the individual trunk cables could be considered to be an upstream terminus. In any case, the cable branches from one (or a few) ports 18ior termini at the upstream end of the cable system to a relatively large number of subscriber locations at which the subscribers 30 are located.

According to an aspect of the invention, the head-end 12 of the cable television system 10 is provided with a “personal computer”, or an equivalent array of servers, which includes a web browser connected in conventional manner to the Internet. This personal computer at the head end is accessible to each subscriber of the system 10 who is provided with a “set-top converter” according to another aspect of the invention. In general, the information from the browser at the head end is encoded so as to be transmitted over the downstream cable paths to the subscriber, and commands directed to the web browser are transmitted to the personal computer from the individual subscribers by way of the return or upstream signal path of the cable television system.

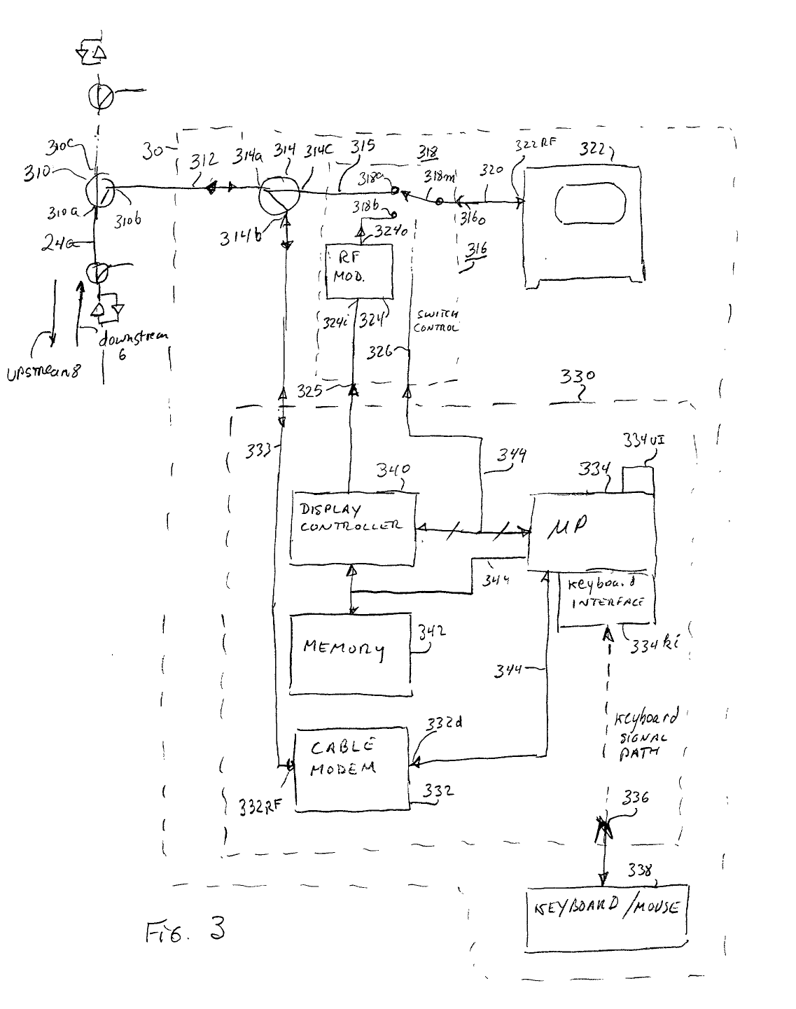

In FIG. 2, antenna 14 is connected to a downconverter 210 of block 16. Downconverter 210 receives the modulated carrier(s) from the satellite, and converts them to baseband or to an IF frequency, as required. The demodulated signals from downconverter 210 are applied to a block 212, which represents processing for each individual television channel. Such processing might include demodulation and remodulation in analog form, or it might include analog-to-digital (A/D) conversion together with digital signal processing. The individual television channels appear on separate communication paths, designated together as 214, at the output of individual channel processing block 212. It should be understood that each individual path within set 214 may include a coaxial cable in the case of analog signals or a set of eight or more individual bit paths in the case of digital signals.

The individual television channels which are to be transmitted over cable to subscribers in FIG. 2 are applied to a block 216, which combines the signals for transmission over the trunk and feeder cables to the subscribers. The combining may include modulation of signals onto carriers, time- or code-division multiplexing, or the like, for providing for the separation of the channels at the subscriber's locations, so that individual channels may be viewed in the normal television viewing use of the cable television system. The combined signals from block 216 are applied to a port 218a of a directional coupler 218, and by way of the through path extending from port 218a to port 218c of the directional coupler, and then by way of the downstream portion of a representative bidirectional amplifier 220, to a trunk cable or to block 18 of FIG. 1, for downstream transmission.

In the arrangement of FIG. 2, upstream transmissions from individual subscribers arrive at directional coupler 218 from the upstream portion of bidirectional amplifier 220 and are coupled by way of the tap 218b and bidirectional path 222 to a block 224. Block 224 represents a cable modem termination system, which includes a receiver for upstream signals from the subscribers, and a transmitter for transmitting signals to the subscribers. Various commands from subscribers, including web browser commands, are received by cable modem termination system 224, and processed, as by demodulation, time- or code-division demultiplexing, or the like, to produce browser commands. The browser commands are applied over an ethernet bus 226 to a personal computer, or its equivalent, which includes web browser 226. The web browser 226 receives subscriber/user commands over bus 226, and produces the appropriate browser action, which is communicated over the ethernet bus 226 to an internet router illustrated as a block 230. Router 230 communicates between web browser 228 and the Internet, illustrated as a cloud 232.

Web browser 228 of FIG. 2 responds to Internet signals received from Internet router 230 by producing signals representing a web page or screen. These page-representative signals are routed over bus 226 to cable modem termination system 224, where they are processed by encoding to a particular subscriber, and modulated as may be required for downstream transmission to the subscriber. The modulated signals are transmitted from cable modem termination system 224, over path 222 to port 218b of directional coupler 218, and by way of the downstream amplifier portion of bidirectional amplifier 220 to the cable television trunk system.

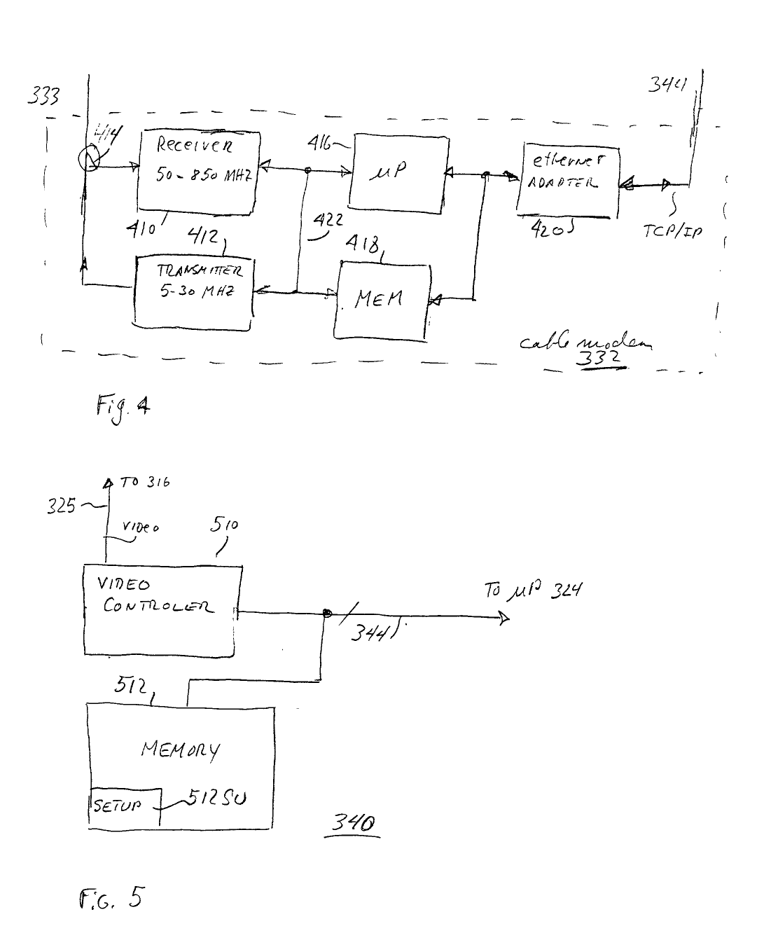

FIG. 3 represents a portion of the cable television system 10 of FIG. 1 near one of the subscriber locations 30. In FIG. 3, a feeder line 24a running outside the subscriber location 30 receives downstream signals in the direction of the arrow, and applies the signals to port 310a of a first directional coupler 310. Most of the signal traverses the through path of coupler 310 extending from port 310a to port 310c, but a portion of the signal is coupled to port 310b. The portion of the downstream signal coupled to port 310b is coupled by way of a signal path 312 to the subscriber location 30, which may be, for example, a house. Within the subscriber location 30, the downstream signals are applied from path 312 to port 314a of a directional coupler 314. A portion of the signal applied to port 314a of directional coupler 314 is coupled by way of a path 315 to a terminal 318a of a controllable switch 318 of a “switch” box 316, and another portion is coupled by way of a port 314b and a path 333 to a cable modem, illustrated as a box 332, within a “set-top” converter or box 330. As described below, the particular cable modem 332 is selected to conform to a particular standard, which in the cable television context may be Eurodocsis 2.1, for example.

Controllable switch 318 of switch box 316 of FIG. 3 is illustrated by a mechanical switch symbol, but those skilled in the art understand that in actual practice, solid-state switches may be used, and the switch control path illustrated as 326 may simply be a control voltage path. Switch representation 318 includes a common movable portion 318m, which is coupled by way of a signal path 320 to the RF input port 322RF of a television receiver 322. The movable portion 318m of switch 318 can be “moved” so as to connect to either terminal 318a or terminal 318b. Terminal 318a receives unmodified or unprocessed downstream signals, including television signals within the frequency ranges which the television set 322 can display. When switch 318 has its movable element 318m in the illustrated upper position, in contact with terminal 318a, television receiver 322 receives conventional cable television signals, and acts in conventional fashion.

Within switch box 316 of FIG. 3, switch terminal 318b is connected to the output port 324o of an RF modulator 324. RF modulator 324 modulates onto a television-frequency carrier any signal applied to its input port 324i by way of path. When switch 318 has its movable element 318m in contact with terminal 318b, the RF input port 322RF of television receiver 322 receives the signals from RF modulator 324, which may be modulated with information. When the information which is modulated onto a television carrier by modulator 324 is a web page, television receiver 322 effectively becomes a monitor for viewing the internet page.

Those portions of the downstream signal coupled from port 314b of directional coupler 314 of FIG. 3 onto path 333 are coupled to cable modem 332. Cable modem 332 receives downstream signals representing, in one situation, the web page currently being accessed by web browser 228 of FIG. 2. Cable modem 332 of FIG. 3 processes the downstream signals, as by downconverting, demodulation, andor time- or code-division demultiplexing, in order to extract information therefrom. Cable modem 332 may also include an analog-to-digital converter, if needed, to convert the signals to digital form. The signals received from the head end by way of the downstream path at cable modem 332 are made available over a digital bus 344 to a microprocessor (μP) illustrated as a block 334. Microprocessor 334 includes a keyboard/mouse interface portion 334ki, which communicates over a path 336 with a keyboard andor a mouse 338. The keyboard coupling path 336 may include an infrared or other type of wireless communication path.

Microprocessor 334 performs signal processing and control functions. In particular, microprocessor 334 compares the downstream signals from cable modem 332 to identify signals destined for the particular subscriber, which are identifiable by a destination address. Microprocessor 334 compares the destination address encoded into the downstream signals with the unique subscriber address, and either acts on the signals if there is a match, or ignores the signals if there is no match. If microprocessor 334 identifies the signals received by cable modem 332 as destined for the particular subscriber, the signals from cable modem 332 are coupled to a memory 332 and to a display controller 340 as they arrive. In general, the received signals will include information representing the web page to be displayed. The information is stored in memory 342, and accessed by display controller 340.

Since the television receiver 322 of FIG. 3 has little or no video storage, any arriving video information would have to be displayed as it arrived. The existence of the video information to be displayed within memory 342 of the set-top converter 330 would not itself be sufficient to allow a continuous display by the television receiver 322. In order to provide a continuous display of the web page stored in memory 342, display controller reads memory 340 continuously or continually, producing a continuous stream of baseband video, and it also converts the video signals into a format suitable for the television receiver 322, as for example PAL, SECAM, or NTSC. The television-compatible signal baseband produced by display controller 340 is applied over path 325 to input port 324i of RF modulator 324. Modulator 324, in turn, converts the television-compatible video signal to a frequency or channel to which the television receiver 322 can tune.

Thus, in general, the web browser 228 of FIG. 2 accesses the Internet under control of upstream-direction commands from a user terminal, and, when a web page is available, processes the web page to produce video which can be identified to a specific subscriber, and which can be transmitted over a downstream path to the subscriber. Of course, use by a plurality of subscribers requires that the computer web browser 228 of FIG. 2 be capable of handling a plurality of users, hence it must be a server-type of arrangement rather than a simple single-user personal computer. The arrangement of the invention is advantageous because the microprocessor within each set-top box need not be of a high-speed type. In one embodiment of the invention, the processor is in the range of 120 Million instructions per second (MIPS). Thus, the set-top box can be cheaper than if it contained the entire web browser; the web browser is located at the head-end, and can be used seriatim by a succession of subscribers, so that the cost of the browser is spread among many subscribers. Since the information transmitted to a particular subscriber is encoded with the subscriber's address or identification, some measure of privacy is available. In addition, the cable modem termination system 224 of FIG. 2 is capable of modulating the signals for the various subscribers in a multiplexed fashion, so that one downstream television channel can be used for many subscribers.

FIG. 4 is a simplified block diagram of a cable modem which may be used in conjunction with the arrangement of FIG. 3. Such cable modems are well known in the art and are readily available from various sources. They differ in their internal design, but are basically as illustrated in FIG. 4. In FIG. 4, radio-frequency modulated signals flowing to cable modem 332 by way of path 333 are routed to a receiver 410 and from a transmitter 412 by way of a directional coupler 414. Receiver 410 downconverts andor demodulates the signals which it receives, and converts them to digital form if not already in digital form. The received digital signals are applied over a bus 422 to a routing or “traffic control” microprocessor 416 and a memory 418. Microprocessor 416 compares the recipient address contained within each received message with an identifier or address unique to the subscriber, to determine if the received message should be acted upon or ignored. If the received message is destined for the subscriber with which the processor is associated, the salient portions of the message are initially stored in memory 418. The message is coupled to an ethernet adapter 420 for transmission in TCP/IP format over bus 344 to the remaining portions of the set-top converter 330. In the reverse direction, TCP/IP format messages arriving at ethernet adapter 420 are coupled to memory 418 for temporary storage and ultimate modulation onto a carrier, and carrier transmission, by transmitter 412. Ordinarily, the downstream signals received by receiver 410 are in the frequency range of 54 to 850 MHz. Receiver 410 will be fixed-tuned to a suitable frequency within that frequency band, even though the receiver may be agile. Transmitter 412 is similarly agile, but fixed-tuned to a selected frequency for a given application.

It should be noted that cable modem 332 of FIG. 3 is preconfigured with knowledge of the address of the head-end computer to which it will be connecting.

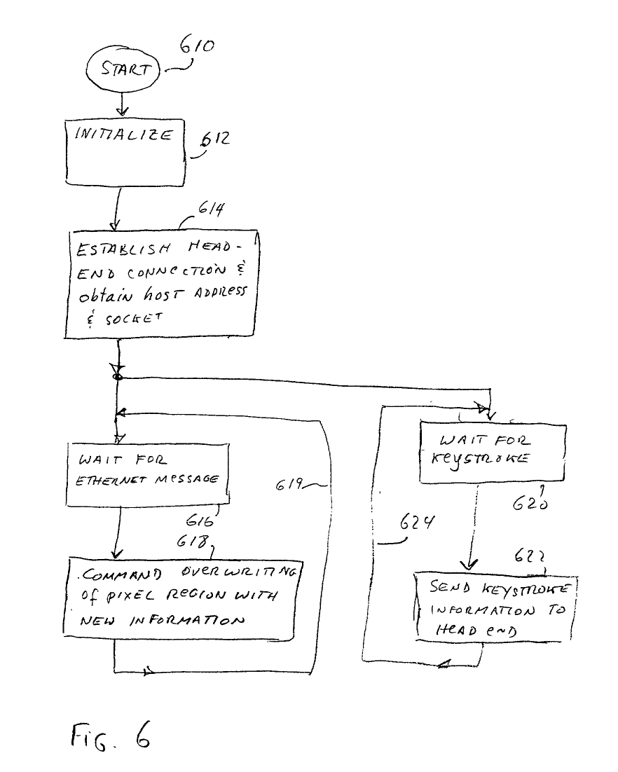

FIG. 5 is a simplified block diagram illustrating details of display controller 340 of FIG. 3. In FIG. 5, display controller 340 includes a video controller 510 connected by way of bus 344 to a memory 512 and to other equipment, such as microprocessor 334, which are not a part of display controller 340. Memory 512 includes a setup portion 512SU which is preloaded with information relating to the parameters such as the size and shape of the display area, the type of color representation (i.e. pixel color depth), interlaced/noninterlaced, and the like. In addition, the setup memory includes information or pointer relating to the location of the raster buffer or pixel array currently in use. This allows the picture to be painted from one pixel array within memory while loading another pixel array. At initial turn-on, video controller 510 reads the setup portion of the memory, and transfers the information to temporary internal storage for use during operation. Once the video controller is set up, it addresses various memory locations in memory 512 under control of the video controller, to recurrently read signals representing the page currently displayed. Thus, for a constant page, it reads the memory 50 times per second for PAL or Secam, and 60 times per second for NTSC. Video controller 510 converts the pixel information into the appropriate baseband one of the PAL, Secam or NTSC formats, or into S-Video, as required, and transmits the television signal over path 325 to modulator 324 of switch 316, from which it may be routed to the television receiver.

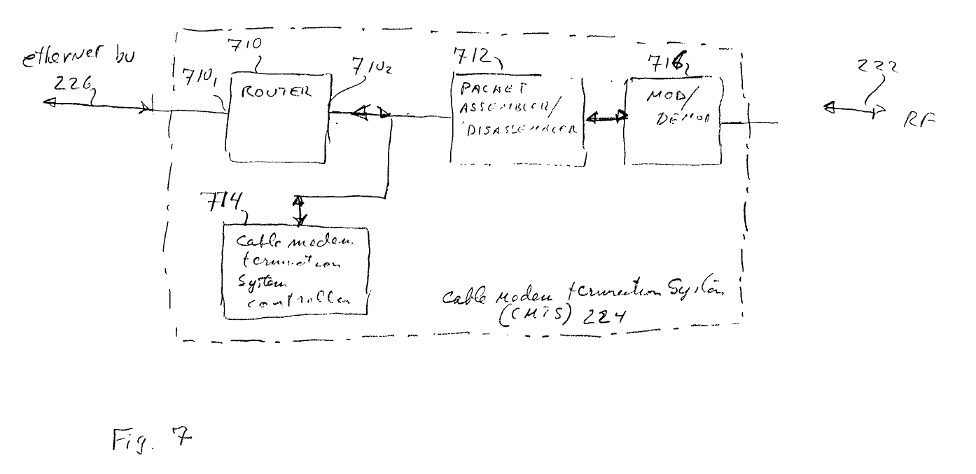

In order to minimize the amount of data which must be transmitted in order to paint the current browser page on the screen of the television receiver, the information is encoded. The code is, for the most part, a difference code, in which only the differences between the current pixel values and the desired pixel values are transmitted. It is possible to combine such difference coding with other coding schemes for further reducing the amount of data necessary to produce the desired picture. In order for the head-end of the system to “know” what is currently being displayed, it includes what is effectively a replica of the receiving system, which can produce a memory representation of what is actually in the memory 342 of its subscriber's display arrangement. Such difference coding systems are known. In the particular embodiment, there are six different coding schemes which are combined to provide the desired result. FIG. 6 is a simplified flow chart or diagram illustrating the principal logic flow paths for processing in processor 334 of FIG. 3. In FIG. 6, the logic begins at a START block 610, and proceeds to a block 612, which represents initialization of the hardware and any index variables which may be required. In addition, block 612 includes the step of reading the identity of the subscriber from a ROM (not illustrated). From block 612, the logic proceeds to a block 614, which represents establishing communications with the head-end browser equipment. This involves commanding the cable modem 332 of FIG. 3 to send an initializing message to the known address of the head end, and waiting for an acknowledgement therefrom, including a host address and port number for the head-end server or host (corresponding to computer web browser 228 of FIG. 2) with which the subscriber will be in communication. From block 614, the logic furcates, and flows to two independent contexts or threads which run or operate simultaneously or concurrently. In the first thread of FIG. 6, the logic leaves block 614 and arrives at a further block 616, which represents a delay until receipt of an ethernet input message from the cable modem on path 344 of FIG. 3 representing one of the six pixel region identification messages, together with the new or updated pixel information for that pixel region. When a pixel region identification message with its data is received, the logic flows to a further block 618, which represents generation of a command directed to the memory 342 of FIG. 3, to store or overwrite the newly arrived pixel information in the identified pixel region. The logic then returns by way of a logic path 619 to block 616, to await arrival of another identified pixel region together with the new information to be overwritten. Thus, this thread merely updates memory 342 as the pixel information arrives. Since this updating is very simple, the difficult processing involving the differences is performed at the head end, where the cost can be distributed over many users. In the second thread of FIG. 6, the logic leaves block 614 and arrives at a block 620, which represents waiting for a keyboard input signal. From block 620, the logic then flows to a further block 622, which represents the commanding of the sending to the head end web browser 228 of FIG. 2 of the keystroke information. The logic then returns by a logic path 624 to block 620 to await another keystroke. Thus, keystrokes are coupled to the head-end browser by the second thread including blocks 620 and 622. It should be noted that no issue of fonts or language arises in the process of painting the picture of transmitting browser commands, as the described process can be used in any language, in any country. It could, for example, be used in China with an ideographically marked keyboard, painting browser screens on the television receiver which include ideographic symbols, without requiring the slightest change to the system, although the browser would have to support the relevant character set, namely Simplified Chinese.

FIG. 7 is a simplified block diagram of cable modem termination system 224 of FIG. 2. Such termination systems are well known in the art, and can be purchased to conform to various standards. The particular standard for the CMTS in an embodiment of the invention is Eurodocsis 2.1, and such CMTS units are available from Cisco Systems. The selected standard defines the coding which is used for communication between cable modem termination system 224 of FIG. 7 and the cable modem 332 of FIG. 3. In FIG. 7, the ethernet bus 226 is connected to an ethernet router 710 portion of CMTS 224. Its function is to listen to the traffic on the ethernet bus, and to provide a through path between ports 710₁ and 710₂ for those messages destined for the cable network. Similarly, it takes traffic arriving at its port 710₂ and which is destined for the outside world and routes it to port 710₁. Signals arriving from the ethernet bus 226 are coupled through router block 710 to a packet assembler/disassembler block 712 and to a cable modem termination system controller 714. Controller 714 assigns time-division multiplex slots to the various currently active subscribers, so that the upstream and downstream information for each subscriber is separated from that of other subscribers. It also assigns internet addresses to the various subscribers for the duration of the subscriber's session, and authenticates users and, in some standards, encrypts the information flowing in the system. Packet assembly/disassembly block 712 is bidirectional, and its function is to receive packets in the one format and to rearrange or repacketize the data for the other format. In this case, the repackaging is between ethernet and a standard set by the CMTS system (Eurodocsis 2.1 in the example). The coded signals produced by packet assembler/disassembler 712 are applied to a bidirectional cable modulator/demodulator 716, which modulates the coded signals onto a downstream carrier for transmission by way of path 222 to downstream locations of the system. Similarly, upstream command information, encoded with the modem standard, from the various subscribers, modulated onto an RF carrier, which arrive at modulator/demodulator 716, are demodulated, and supplied to packet assembler/disassembler 712. Thus, the web browser commands which are modulated onto an upstream RF carrier are ultimately coupled to ethernet path 226, and web page information applied to CMTS 224 from ethernet path 226 is converted to the modem standard, modulated onto an RF carrier, and transmitted in a downstream direction.

Other embodiments of the invention will be apparent to those skilled in the art. For example, while the functional elements such as the memory and the video processor have been described as separate devices, they may physically be combined into one board, subassembly or chip. While the subscriber converter has been described as a “set-top” box or converter, the location of the converter is irrelevant, so long as the appropriate connections are provided. While the directional coupler 314 of FIG. 2 and the switch 316 of FIG. 2 have been illustrated as separated from the converter 330, this merely illustrates one anticipated way of using the arrangement, and either or both may be incorporated within the same housing as the converter.

Thus, a system (10) according to an aspect of the invention is for delivering television and internet access to a plurality of subscribers (30) lacking web browsers. The system (10) includes a bidirectional path (20a) defining an upstream direction (8) and a downstream direction (6), and branching from a small number (one) of termini or locations at the upstream (6) terminus of the bidirectional path (20a) to a large number of subscriber locations at the downstream (6) termini of the bidirectional path (20a). A hub (12) is located at one of said small number of locations. In a preferred embodiment of the invention, the upstream (8) hub (12) is a head-end of a cable television system, and the bidirectional path is a cable distribution system. The system (10) includes a source (14,16) of television signals at the hub (12), for generating a plurality of television signals modulated onto radio-frequency carriers, and television signal coupling means (18) at the hub (12) for coupling the television signals modulated onto radio-frequency carriers to the at least one bidirectional path (20a), whereby, or as a result of which, the television signals are transmitted in a downstream (6) direction over the at least one path to the plurality of subscribers (30). The system (10) also includes at least one web browser (228) associated with the hub (12) for accessing the Internet under control of subscriber command signals applied thereto, and generates signals representative of web pages. A browser page coding arrangement (710, 712, 714) is located at the hub (12), and is coupled to the web browser (228), for converting the signals representative of web pages into digital signals encoded with identifier information unique to that one of the subscribers (30) using the web browser (228). A modulating arrangement (716, 218) is located at the hub (12) and is coupled to the coding arrangement (710, 712, 714) for modulating the digital signals encoded with identifier information onto an RF carrier, and for coupling the resulting web page information carrier onto the downstream (6) direction of the bidirectional path (20a), whereby, or as a result of which, the digital signals which are encoded with identifier information arrive at all the subscriber locations. The system (10) further includes a modem (332) located at each subscriber (30) location. The modem (332) includes an RF port (332RF) and a digital signal port (332d), for demodulating the modulation on a carrier having the frequency of the RF carrier applied to the RF port (332RF), and for coupling the resulting signals to the digital port (332d), and for modulating digital signals arriving at the digital port (332d) onto a carrier at the frequency of the RF carrier. At each subscriber (30) location, an arrangement (314, 315, 318) is provided for routing to a television receiver (322) those television signals arriving from the hub (12), and for routing the RF carrier flowing in the downstream (6) direction of the bidirectional path (20a) to the RF port (332RF) of the modem (332), and for routing the carrier at the frequency of the RF carrier from the RF port (332RF) of the modem (332) to flow in the upstream (8) direction in the bidirectional path (20a). At each subscriber (30) location, controllable memory (342) is provided for temporary storage of the signals representative of web pages. At each subscriber location, a means (334) is provided, which means (334) is coupled to the digital port (332d) of the modem (332) for reading the identifier information, for comparing the identifier information with stored identifier information unique to the subscriber, and for (a) commanding the memory (342) to store the signals representative of web pages when the identifier information indicates that the web pages are destined for the local subscriber, whereby the memory (342) updates at least a portion of its contents, and for (b) not commanding the memory (342) when the identifier information indicates that the web pages are destined for a subscriber other than the local subscriber, whereby, or in which case, the memory (342) continues to store its current information contents. At each subscriber location of the system (10), a display control and modulation arrangement (316, 340) is coupled to the memory (342), for recurrently reading the memory (342), and for converting the information so read into television format signals modulated onto a television-frequency carrier, to thereby form television signals representative of the web page. At each subscriber location, means (318) are provided for coupling the television signals representative of the web page to a television receiver (322) for display of the web page thereon. At each subscriber location, a subscriber command interface (338) reading arrangement (334ki) is coupled to the modem (332), for receiving (from 338) subscriber commands related to the web browser (228), and for coupling the subscriber commands to the digital port (332d) of the modem (332), whereby the modem (332) modulates the subscriber commands for transmission in the upstream (8) direction over the bidirectional path (20a) to the hub (12). At the hub (12), a further modem function, which may be a bidirectional function of the cable modem termination system (224 of FIG. 7) and the associated browser page coding arrangement, is provided for receiving and demodulating the subscriber commands, and for coupling the commands to the web browser is (228).

According to another aspect of the invention, a cable television subscriber set-top converter (314,316,330) lacks a web browser, and includes a memory (334UI) holding an identifier unique to the subscriber, at least in the cable television system with which it is used. The converter (314,316,330) includes a broadband communications input port (314a) for receiving television signals modulated onto RF carriers and digital web page video signals identified, by carrying the unique identifier, as destined to a particular subscriber. An arrangement (315, 318) is provided for coupling the cable television signals to a television receiver signal port (316o), to which the RF input port (322RF) of a television receiver (322) may be coupled. The converter (314,316,330) also includes an arrangement (314a, 314bc) for coupling the digital web page video signals to a cable modem (332). The cable modem (332) is for converting the digital web page video signals into a format according to a predetermined standard, which may be TCP/IP in one embodiment, and for coupling the video signals in that predetermined standard onto a bus (344). A memory (342) and a processor (334) are coupled to the bus (344). The processor (334) reads the unique identifier, and causes the memory (342) to be updated, at least in part, only in response to correspondence between the unique identifier of the identifier memory (334UI) of the associated converter (314,316,330) and the identifier associated with the received video signals. Thus, the memory (342) is updated only with information relating to a web page destined for the local subscriber. The processor (334) further includes a user input device interface (334ki), and couples user commands applied to the user input device interface (334ki) to the cable modem (332). A display controller (340) is coupled to the bus (344), for recurrently reading the memory (342), to thereby recurrently produce a stream of data representing a scanned web page, and for converting the stream of data into signals conforming to a standard baseband television format. An RF modulator (324) is coupled to the display controller (340) for receiving the signals conforming to a standard baseband television format, and for converting the signals into a radio-frequency television signal. An arrangement (324o, 318b, 318m) is coupled to the RF modulator (324) and to the television receiver signal port (316o), for making the radio-frequency television signal accessible to an external television receiver (322), preferably the same one which is used to view the conventional downstream television signals. A user input device signal input port (336) is coupled to the user interface input port (334ki) of the processor, for providing a path for the flow to the processor (334) of subscriber web command signals produced by an external input device (338). As a result, or whereby, the processor (334) couples the commands to the cable modem (332), and the cable modem modulates the commands onto an upstream RF carrier. As a result, each subscriber can command, from his location, a web browser which is remote from the location of the subscriber, and view the web pages resulting from commands on a television receiver.

What is claimed is:

1. A cable television subscriber set-top converter including a memory holding an identifier unique to the cable television system with which it is used, and lacking a web browser, said converter comprising:
a broadband communications input port for receiving television signals modulated onto RF carriers and digital web page video signals identified, by carrying said unique identifier, as destined to a particular subscriber;
means for coupling said cable television signals to a television receiver signal port;
means for coupling said digital web page video signals to a cable modem, for converting said digital web page video signals into a format according to a predetermined standard, and for coupling said video signals in said predetermined standard onto a bus;
a memory and processor coupled to said bus, for responding only to those of said video signals identified by said unique identifier by causing said memory to refresh information relating to at least portions of said web page, said processor further including a user input device interface, and providing for the coupling of user commands applied to said user input device interface to said cable modem;
a display controller coupled to said bus, for recurrently reading said memory to thereby recurrently produce a stream of data representing a scanned web page, and for converting said stream of data into signals conforming to a standard baseband television format;
an RF modulator coupled to said display controller for receiving said signals conforming to a standard baseband television format, and for converting said signals into a radio-frequency television signal;
means coupled to said RF modulator and to said television receiver signal port, for making said radio-frequency television signal accessible to an external television receiver;
a user input device signal input port coupled to said user interface input port of said processor, for providing a path for the flow to said processor of subscriber web command signals produced by an external input device, whereby said processor couples said commands to said cable modem, and said cable modem modulates said commands onto an upstream RF carrier, and whereby each subscriber can command from his location a web browser which is remote from the location of said subscriber, and view the web pages resulting from said commands on a television receiver.

2. A cable television subscriber set-top converter, comprising:
a broadband communication input port, for receiving a broadband signal representing a plurality of difference signals, each of which difference signals represents the difference between a desired display buffer frame and the current display buffer frame for one of a plurality of subscribers, and for transmitting at least application control signals associated with said subscriber;
a memory preloaded with a unique internet protocol address:
a display buffer memory including memory locations for each pixel of a current display buffer frame;
a converter for converting said broadband signals to baseband, to thereby generate baseband digital signals representing said plurality of difference signals;
an address filter coupled to said memory for receiving at least a portion of said unique internet protocol address, for selecting that portion of said baseband digital signals intended for the set-top subscriber converter, to thereby generate selected difference signals;
a display buffer memory control circuit coupled to receive said selected difference signals, for updating identified pixels of said display buffer memory with information associated with said selected difference signals, whereby said display buffer memory contains the currently desired frame;
display buffer memory reading means coupled to said display buffer memory, for reading at least a portion of said display buffer memory, and for producing time-sequential video signals; and
a modulator coupled to said display buffer memory reading means, for modulating said time-sequential video signals onto a television carrier frequency.

3. A system for delivering television and internet access to a plurality of subscribers lacking web browsers, said system comprising:
a bidirectional signal path branching from a relatively small number of upstream termini to a larger number of downstream subscriber termini at various locations;
a hub located at and coupled to an upstream terminus of said bidirectional signal path;
a source of television signals at said hub, for generating a plurality of television signals modulated onto radio-frequency carriers;
television signal coupling means at said hub, for coupling said television signals modulated onto radio-frequency carriers to said upstream terminus of said at least one bidirectional path, whereby said television signals are transmitted in a downstream direction over said at least one path to said plurality of subscriber termini;
at least one web browser associated with said hub for accessing the Internet under control of subscriber command signals applied thereto, and for generating signals representative of web pages;
browser page coding means located at said hub, and coupled to said web browser, for converting said signals representative of web pages into digital signals encoded with identifier information unique to that one of said subscribers using said web browser;
modulating means located at said hub and coupled to said coding means for modulating said digital signals encoded with identifier information onto an RF carrier, and for coupling the resulting web page information carrier onto the downstream portio of said bidirectional path, whereby said digital signals which are encoded with identifier information arrive at all said subscriber locations;
a cable modem located at each subscriber location, said modem including an RF port and a digital signal port, for demodulating the modulation on a carrier having the frequency of said RF carrier, and for coupling the resulting signals to said digital port, and for modulating digital signals arriving at said digital port onto a carrier at said frequency of said RF carrier;
at each subscriber location, means for routing to a television receiver those television signals arriving from said hub, and for routing said RF carrier flowing in the downstream direction of said bidirectional path to said RF port of said modem, and for routing said carrier at said frequency of said RF carrier from said RF port of said modem to flow in the upstream direction in said bidirectional path;
at each subscriber location, controllable memory for temporary storage of said signals representative of web pages;
at each subscriber location, means coupled to said digital port of said modem for reading said identifier information, for comparing said identifier information with stored identifier information unique to said subscriber, and for (a) commanding said memory to store said signals representative of web pages when said identifier information indicates that said web pages are destined for the local subscriber, whereby said memory updates at least a portion of its contents, and for (b) not commanding said memory when said identifier information indicates that said web pages are destined for another subscriber, whereby said memory continues to store its current contents;
at each subscriber location, display control and modulation means coupled to said memory, for recurrently reading said memory, and for converting the information so read into television format modulated onto a television-frequency carrier to thereby form television signals representative of the web page;
at each subscriber location, means for coupling said television signals representative of the web page to a television receiver for display of said web page thereon;
at each subscriber location, subscriber command interface reading means coupled to said cable modem, for receiving subscriber commands related to said web browser, and for coupling said subscriber command to said digital port of said modem, whereby said modem modulates said subscriber command for transmission in the upstream direction over said bidirectional path to said hub;
at said hub, a modem function, which may be a bidirectional aspect of said modulating means and said browser page coding means, for receiving and demodulating said subscriber commands, and for coupling said commands to said web browser.

4. A system according to claim 3, wherein said bidirectional path is a cable distribution network, and said hub is a head-end.
